(19) United States
(12) Patent Application Publication
(10) Pub. No.: US 2006/0009245 A1
(43) Pub. Date: Jan. 12, 2006

(54) Wireless audio transmission/reception system and using method therefor

(75) Inventors: Min Young Hur, Kyoungsangnam-do (KR); Hyun Yun Shin, Kyoungsangbuk-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/178,376

(22) Filed: Jul. 12, 2005

(30) Foreign Application Priority Data
Jul. 12, 2004 (KR) 54137/2004
Jul. 7, 2005 (KR) 61420/2005

(51) Int. Cl. H04B 7/00

(52) U.S. Cl. 455/500

(57) ABSTRACT

A wireless audio transmission/reception system is provided. The transmission/reception system includes an FM detector for detecting an occupied channel among radio FM channels, a microprocessor for selecting a using channel that is greatly different in frequency from the detected occupied channel and thus does not interfere therewith, an FM transmitter built in an audio replay system to transmit/receive an audio signal over the using channel, and an external audio system for receiving and outputting the audio signal from the FM transmitter.

### BACKGROUND OF THE INVENTION

1. Field of the Invention

The present invention relates to a wireless audio transmission/reception system and a method for a radio frequency (RF) setting method therein, and particularly, to a wireless audio transmission/reception system and a using method therefor that allow a user to listen to an audio from an audio replay system by wireless. More particularly, the present invention relates to a wireless audio transmission/reception system and a using method therefor that can enhance user convenience and satisfaction by setting exact transmission/reception frequencies when audio signals reproduced by an audio replay system are transferred to an external audio system by an FM transmitter.

2. Description of the Related Art

When an audio replay system (e.g., an MP3 player) and an external audio system (e.g., a car audio system) are separated from each other, an FM transmitter transmits audio signals reproduced by the audio replay system to the separate external audio system by wireless, thereby allowing a user to listen to the audio in a convenient and comfortable environment.

Since the FM transmitter is a radio-based device, it uses a specific FM frequency. The FM transmitter must use only predetermined frequency bands for nations and regions according to an international agreement regarding the use of radio frequency. Also, general radio broadcasting uses predetermined frequency bands assigned to each nation. In this case, a frequency band used for radio communication by an FM transmitter may closely neighbor the radio broadcasting frequency band. Accordingly, there is a high possibility that a frequency signal used by the FM transmitter might interfere with a frequency signal used by the general radio broadcast.

To solve this drawback, the FM transmitter sets available frequency channels and has different frequency channels used for radio communication according to an area where an apparatus is disposed. However, it is very difficult for a user to select a desired frequency channel among the available frequency channels.

To solve this problem, a frequency band capable of avoiding a radio frequency band used in a specific region may be set in the FM transmitter in advance. However, radio frequency signals include not only a signal of a predetermined frequency used but also a signal in a different frequency band that may interfere with the original frequency. Accordingly, such a method is not desirable.

An apparatus such as the audio replay system is disposed inside the building, specifically a room. Therefore, interference between radio signals, signals reflected by the building, and electromagnetic wave signals due to other neighboring electronic devices greatly affect the apparatus. Therefore, it is problematic to have the audio replay system disposed inside the building transmit and receive audio signals over a predetermined radio frequency.

Accordingly, there is required a method in which a frequency, over which wireless transmission between an audio replay system and an external audio system is performed via a wireless audio transmission/reception system, is automatically selected according to a current time and a current position of the system.

### SUMMARY OF THE INVENTION

Accordingly, the present invention is directed to a wireless audio transmission/reception system and a using method therefor that substantially obviate one or more problems due to limitations and disadvantages of the related art.

An object of the present invention is to provide a wireless audio transmission/reception system and a using method therefor, which can conveniently obtain an optimal audio TX/RX frequency.

Another object of the present invention is to provide a wireless audio transmission/reception system and a using method therefor, which can conveniently set an optimal frequency.

A further another object of the present invention is to provide a wireless audio transmission/reception system and a using method therefor, which can conveniently set an optimal audio TX/RX frequency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a wireless audio transmission/reception system including: an FM detector for detecting an occupied channel among radio FM channels; a microprocessor for selecting a using channel that is greatly different in frequency from the detected occupied channel and thus does not interfere therewith; an FM transmitter built in an audio replay system to transmit/receive an audio signal over the using channel; and an external audio system for receiving and outputting the audio signal from the FM transmitter.

In another aspect of the present invention, there is provided a wireless audio transmission/reception system including: an audio replay system including: an FM detector for detecting an occupied channel among radio FM channels; a microprocessor for automatically selecting a using channel not interfering with the detected occupied channel through a predetermined algorithm; and an FM transmitter built in an audio replay system to transmit/receive an audio signal over the using channel; and an external audio system including an FM receiver for receiving and outputting the audio signal from the FM transmitter.

In a further another aspect of the present invention, there is provided a wireless audio transmission/reception system including: an external audio system including: an FM detector for detecting an occupied channel among radio FM channels; a microprocessor for automatically selecting a using channel not interfering with the detected occupied channel through a predetermined algorithm; and a speaker for outputting an audio signal; and an audio replay system including an FM transmitter for transmitting the audio signal over the using channel.

In a still another aspect of the present invention, there is provided a wireless audio transmission/reception system including: an audio replay system including: an FM transmitter for transmitting an audio signal over a using channel of a predetermined frequency band; and a microprocessor for selecting a using channel not interfering with radio FM channels through a predetermined algorithm; and an external audio system including: an FM receiver for detecting a radio FM occupied channel and receiving an audio signal from the FM transmitter; and a speaker for outputting an audio signal.

In a yet another aspect of the present invention, there is provided a method for using a wireless audio transmission/reception system, the method including the steps of: searching a radio FM occupied channel of an audio replay system; selecting one or more possible channels greatly different in frequency from the occupied channel; selecting a using channel from the possible channels; and transmitting an audio signal over the using channel at an FM transmitter of the audio replay system, and receiving and outputting the audio signal at an external audio system.

In a still yet another aspect of the present invention, there is provided a method for using a wireless audio transmission/reception system, the method comprising the steps of: searching a radio FM occupied channel of an audio replay system; transmitting information about the occupied channel to the audio replay system; selecting a using channel not interfering with the occupied channel; and transmitting an audio signal over the using channel at an FM transmitter of the audio replay system, and receiving and outputting the audio signal at the external audio system.

Accordingly, an optimal TX/RX frequency can conveniently obtained and thus user convenience is enhanced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a wireless audio transmission/reception system according to a first embodiment of the present invention;

FIG. 2 is a flowchart illustrating a method of using the wireless audio transmission/reception system according to the first embodiment of the present invention;

FIG. 3 is a diagram illustrating a process of selecting a possible channel in the wireless audio transmission/reception system according to the first embodiment of the present invention;

FIG. 4 is a block diagram of a wireless audio transmission/reception system according to a second embodiment of the present invention; and

FIG. 5 is a flowchart illustrating a method of using a wireless audio transmission/reception system according to a third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

### First Embodiment

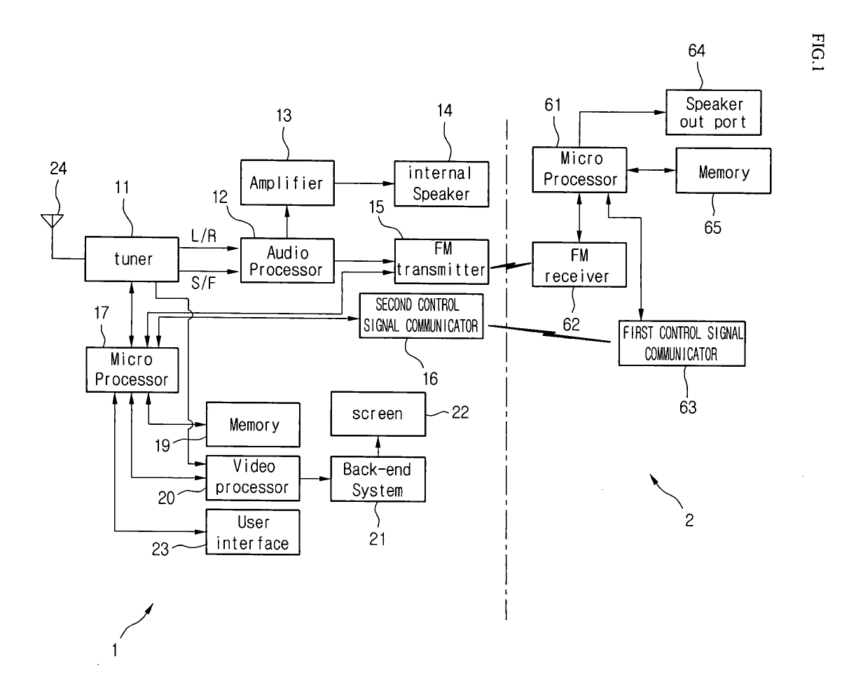

FIG. 1 is a block diagram of a wireless audio transmission/reception system according to a first embodiment of the present invention.

Referring to FIG. 1, a wireless audio transmission/reception system includes an audio replay system 1 and an external audio system 2. The audio replay system 1 is an audio output system that can replay audio. For example, the audio replay system 1 may a MP3 player, a display device, a mobile terminal, a DVD player, a VCR, a Set-top box, a personal computer, a game device, a camcorder, or the like. The external audio system 2 is spaced apart from the audio replay system 1. The external audio system 2 is a speaker-equipped system such as a car audio, an audio system, a speaker, and a remote controller.

A display device and a remote controller are exemplarily illustrated as the audio replay system 1 and the external audio system 2 to describe the present invention.

Hereinafter, the wireless audio transmission/reception system of the present invention will now be more fully described.

The audio replay system 1 includes an RF antenna 24 to receive RF signals from broadcasting stations, a tuner 11 to select a desired signal from the RF signals received by the RF antenna 24, an audio signal output unit to extract audio signal from the selected RF signal, a video signal output unit to output a video signal, and a controller such as a microprocessor 17.

The audio signal output unit includes an audio processor 12 to extract an audio signal from the RF signal selected by the tuner 11, an amplifier 13 to amplify the extract audio signal, an internal speaker 14 to convert the amplified audio signal into sound, and an FM transmitter 15 to transmit a radio signal at an FM frequency. The FM transmitter 15 transmits an audio signal to the external audio system 2 at an FM frequency, and the microprocessor 17 controls an FM frequency channel of the FM transmitter 15.

The video signal output unit includes a video processor 20 to process a video signal received from the tuner 11 under the control of the microprocessor 17, a back-end system 21 to perform a back-end process such as deflecting and scanning on the video signal from the video processor 20, and a screen 22 to display the video signal.

Also, a user interface 23 is provided for a user to adjust functions of the audio replay system 1. Further, a memory 19 is provided to store data requiring for the operation of the audio replay system 1.

The external audio system 2 includes an FM receiver 62 to receive an FM signal from the FM transmitter 15, a controller such as a microprocessor 61 to control its operation, a memory 65 to store data, and a speaker out port 64 to output the received FM signal under the control of the microprocessor 61. The speaker out port 64 may be connected to a speaker or a earphone.

An operation of the wireless audio transmission/reception system will not be described.

Audio and video signals selected by the tuner 11 are outputted by the audio signal output unit and the video signal output unit, respectively. Generally, the audio signal is outputted by the internal speaker 14. However, when a user wants to radio the audio signal to the external audio system 2 in order to output the audio signal using the external audio system 2, the user can manipulate the audio replay system 1 through the user interface 23.

That is, when the user manipulates the user interface 23 to send the audio signal to the external audio system 2, the microprocessor 17 controls the audio processor 12 to outputs the audio signal to the FM transmitter 15. The FM transmitter 15 transmits the audio signal to the FM receiver 62 of the external audio system 2, and then the audio signal is outputted to the speaker out port 64.

To transmit and receive a control signal, the audio replay system 1 includes a second control signal communicator 16, and the external audio system 2 includes a first control signal communicator 63. The control signal communicators 16 and 63 are respectively connected to the microprocessors 17 and 61, such that the microprocessors 17 and 61 can receive the control signal.

The control signal communicators 16 and 63 can be operated in accordance with various communication protocols. For example, IR modules (infrared communication), Bluetooth modules, or IEEE802.11b modules can be used for the control signal communicators 16 and 63. That is, any kind of communication protocol can be used to transmit and receive a control signal between control signal communicators 16 and 63.

The FM receiver 62 of the external audio system 2 receives an FM signal from the FM transmitter 15 and as well detects FM channels of broadcasting stations. That is, the FM receiver 62 can perform the function of a FM detector. The FM receiver 62 sends the FM broadcasting channel information to the microprocessor 61, such that the microprocessor 61 can select an appropriate channel for the communication between the audio replay system 1 and the external audio system 2 without interference with the FM broadcasting channels.

In detail, the microprocessor 61 selects a channel between the FM broadcasting channels, examines the selected channel whether it is suitable for the communication between the audio replay system 1 and the external audio system 2, and if so, uses the selected channel as a communication channel for the communication between the audio replay system 1 and the external audio system 2. Through the communication channel, an audio signal is transmitted from the audio replay system 1 (FM transmitter 15) to the external audio system 2 (FM receiver 62). Then, the external audio system 2 plays the received audio signal for a user.

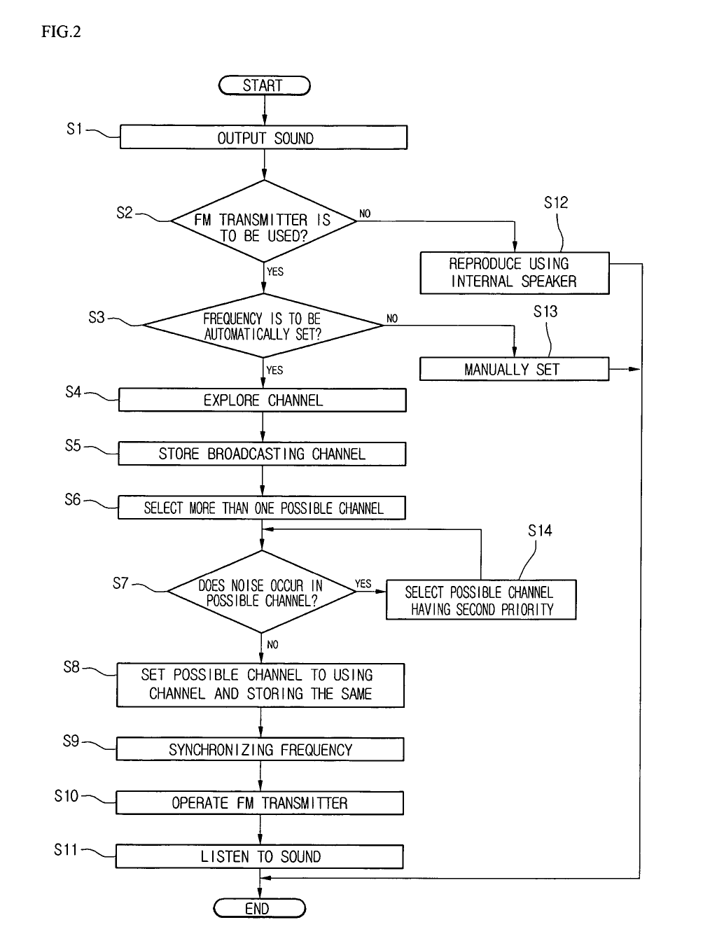

FIG. 2 is a flowchart illustrating a method of using the wireless audio transmission/reception system according to the first embodiment of the present invention.

Referring to FIG. 2, when the inventive wireless audio transmission and reception system starts to operate, an audio output starts (Step S1) and whether to use the FM transmitter 15 is determined (Step S2). At this point, when a user does not intend to use the FM transmitter 15, audio signals are outputted and the audio signals may be outputted through the internal speaker 14 unless a user's command is provided separately (Step S12).

In the case where a user intends to use the FM transmitter 15, whether to automatically set a frequency is further determined (Step S3). In Step S3, when a user intends to manually set a using channel, a user manually matches the frequency of the FM transmitter 15 with that of the FM receiver 62 and checks audio signals outputted from the speaker output port 64, so that an appropriate frequency is set (Step S13).

In the case where a user intends to automatically set a using channel as a result of Step S3, a subsequent step is further performed. The Step S3 will be described in more detail below.

First, a step of exploring, at the FM receiver 62, an occupied channel, which is an FM channel through which broadcasting is performed using a sky wave at a current location, is performed (Step S4). Information of the explored occupied channel is transferred to the controller 61 and stored in the memory 65 (Step S5). After that, the controller 61 selects at least one possible channel appropriate for transmission and reception between the FM transmitter 15 and the FM receiver 62 with reference to the occupied channel (Step S6). The possible channel may be set to a frequency occupying an about central portion of the frequency band occupied by a pair of occupied channels. By doing this, since the possible channel comes to have a frequency greatly different from that of the occupied channel, there is small possibility that interference occurs.

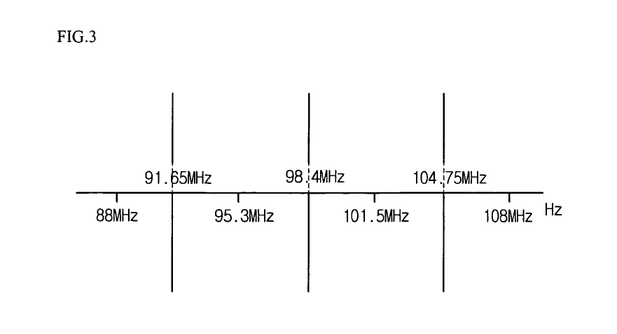

A process of selecting the possible channel will be described in more detail with reference to FIG. 3.

Referring to FIG. 3, the occupied channel is explored as 88.0, 95.3, 101,5, and 108.0 MHz. With that state, the possible channel can be selected to the first possible channel of 91.65 MHz, which is the central frequency in the frequency band of 88.0-95.3 MHz, the second possible channel of 98.4 MHz, which is the central frequency in the frequency band of 95.3-101.5 MHz, and the third possible channel of 104.75 MHz, which is the central frequency in the frequency band of 101.5-108.0 MHz. From the above, it is revealed that the possible channel is the farthest frequency band in the occupied channel. The farthest frequency band is selected as described above, so that there is little possible that interference occurs in the using channel.

Also, the possible channel has priority, which can be determined according to a degree the possible channel is distant away from the occupied channel. According to such a degree, since the first possible channel is distant away from the occupied channel by 3.65 MHZ, the first possible channel has the first priority. Similarly, since the third possible channel is distant away from the occupied channel by 3.25 MHz, the third possible channel has the second priority. Also, since the second possible channel is distant away from the occupied channel by 3.10 MHz, the second possible channel can have the third priority.

According to such a degree, the first possible channel has the highest possibility of being set as the optimum frequency for radio transmission/reception, the third possible channel has the next high possibility, and the second possible channel has the lowest possibility. Therefore, a subsequent step of verifying a possible channel may be performed in the order of the first possible channel, the third possible channel, and the second possible channel.

After the possible channel is selected as described above, a step of verifying the possible channel is performed (Step S7). In detail, the step of verifying the possible channel can be performed through a process of analyzing a noise of a frequency received after the FM receiver 62 is set to the frequency band of the possible channel. In the step of verification, a signal received from the FM receiver 62 through a predetermined possible channel is amplified, detected, rectified, and DC-planarized. When a DC level of the planarized signal exceeds a predetermined reference DC level, it is judged that the possible channel has a noise and thus cannot be used for a using channel. For example, when a DC level of a signal received through the first possible channel is 2V and the reference DC level is 1V, the first possible channel is judged not to be used for a using channel. There are several cases where a channel selected first as the possible channel cannot be used for a using channel. For example, despite the possible channel already contains sky wave brocading, when the broadcasting signals are so weak, the FM receiver 62 cannot detect the signals. The FM receiver cannot properly detect broadcasting signals when interference waves occur due to a local environment factor. Of course, it is possible to perform the step of verifying the possible channel using other methods, not the method of analyzing a noise by measuring a DC level.

When the first possible channel is not selected for the using channel, the possible channel having the second priority is verified (Step S14). As descried above, the selecting of the possible channel may be performed in the order of the first possible channel, the third possible channel, and the second possible channel for the case as exemplified in FIG. 3.

When a noise is not found in the possible channel currently under verification during the step of verifying the possible channel (Step S7), the current possible channel is set for a using channel, a frequency thereof is stored in the memory 65, and the current possible channel is set for a using channel of the FM receiver 62, too (Step S8).

After that, information of the using channel set by the external audio system 2 is synchronized with the audio reproducing system 1 (Step S9). The process of synchronizing (Step S9) includes: transmitting, at the first control signal communicator 63, the information of the using channel to the second control signal communicator 16 under control of the controller 17; delivering, at the second control signal communicator 16, the received information of the using channel to the controller 17; and storing, at the controller 17, the delivered information in the memory 19 of the audio reproducing system 1 and setting, at the controller 17, the delivered information to the FM transmitter 15.

After that, the FM transmitter 15 transmits audio signals through the frequency of the using channel (Step S10) and the FM receiver 62 receives information transmitted from the FM transmitter 15 and reproduces the received information through the speaker out port 64, so that a user may listen to audio signals (Step S11).

Since the audio reproducing system 1 is a display device, a user can watch a video through the screen 22 as well as listening to audio signals.

According to the above-described method, a user can automatically set an optimum frequency required for operation of the FM transmitter without making an effort separately.

### Second Embodiment

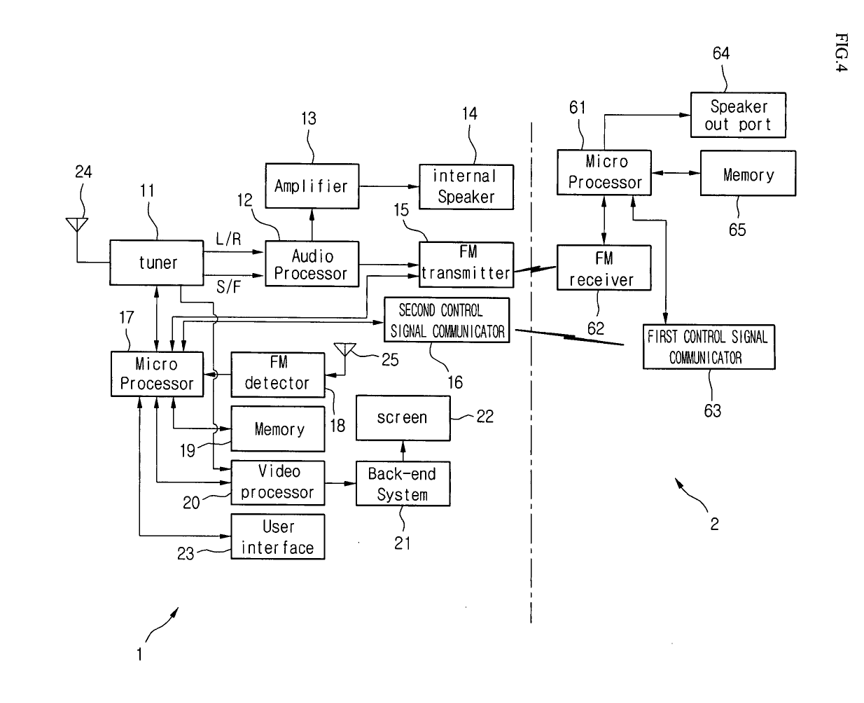

FIG. 4 is a block diagram of a wireless audio transmission/reception system according to a second embodiment of the present invention.

The second embodiment of the present invention is the same as the first embodiment except that the process of setting the using channel is set by the audio reproducing system 1, not by the external audio system 2. Therefore, descriptions of parts not mentioned particularly in the second embodiment are the same as those in the first embodiment. Only different part will be described below.

FIG. 4 is a block diagram of a wireless audio transmission/reception system according to the second embodiment of the present invention.

Referring to FIG. 4, the audio reproducing system 1 further includes an FM detector 18 for exploring a radio FM channel and an FM antenna 25 for transmitting radio signals to the FM detector 18.

With such a structure, after information of the FM channel explored by the FM antenna 25 and the FM detector 18 is delivered to the controller 17 of the audio reproducing system 1, the controller 17 selects a using channel. Also, information of the selected using channel is delivered to and set in the external audio system 2.

Of course, the process of setting the using channel can include: selecting a possible channel; and verifying the possible channel.

The second embodiment may be applied to the case where operation stability of the external audio system is not secured and thus the process of selecting the using channel cannot be performed reliably.

### Third Embodiment

The third embodiment is identical to the second embodiment with the exception that transmission/reception of a control signal between the audio replay system and the external audio system is differently performed in the embodiments.

In the first and second embodiments, one of the audio replay system and the external audio system receives a radio broadcast signal, detects an occupied channel that is currently used, selects a possible channel using the occupied channel, set the possible channel to a using channel, and transmits information about the using channel to the other system.

However, the first embodiment is problematic in that the external audio system with a low capacity should perform a complex operation. Also, the second embodiment is problematic in that the audio replay system should additional include an FM detector 18 and an FM antenna 25.

To solve these problems, it is more preferable to utilize the high operation capability of the controller 17 in the audio replay system and the search function of the FM receiver 62 built in the external audio system.

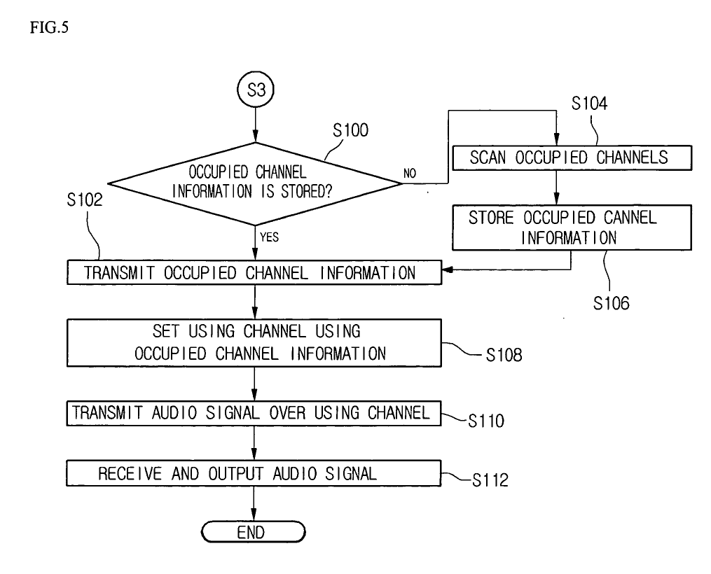

FIG. 5 is a flowchart illustrating a method of using a wireless audio transmission/reception system according to a third embodiment of the present invention.

Referring to FIGS. 1 and 5, audio output is initiated (Step S1), whether or not the FM transmitter is used is determined (Step S2), and whether or not a frequency automatic setting mode is used determined (Step S3). Thereafter, whether or not information about the occupied channel is stored in the external audio system 2 is determined (Step S100).

If the occupied channel information is not stored in external audio system 2, occupied channels are scanned by the receiver 62 (Step S104). Information about the occupied channels is stored in the memory 65 (Step S106).

Thereafter, the occupied channel information stored is transmitted through the control signal communicators 16 and 63 to the audio replay system 1 (Step S102). In this case, the external audio system does not need a high-capacity microprocessor because it merely performs the search operation by the FM receiver 62.

Next, a using channel is selected using the occupied channel information at the audio replay system 1 (Step S108). This channel selection process is identical to that of the first and second embodiments.

The selected using channel is stored in the memory 19 and is set in the FM transmitter 15. Thereafter, an audio signal is transmitted over the using channel (Step S110). Next, the transmitted audio signal is received at the external audio system 2 through the FM receiver 62 and is then outputted (Step S112).

In Step S108, information about the using channel may be automatically transmitted from the audio replay system to the external audio system of course, the using channel information may be displayed by the audio replay system 1 and a using channel may be manually set by the user through the displayed using channel information.

In this case, the audio replay system 1 does not need an additional unit for frequency search, and thus is simplified in structure and enhanced in an operational reliability.

In another embodiment, when the external audio system has a large capacity and the audio replay system has a small capacity, the audio replay system may search the occupied cannel and the external audio system may select the using channel according to information about the occupied channel.

When the control signal communicator 16 and 63 are not installed in the audio replay system 1 and/or the external audio system 2, a control signal cannot be communicated. In this case, the using channel information may be displayed by a display unit in one of the two systems, which selects the using channel, and the selected using channel information may be manually set in the other system by the user according to the displayed using channel information. This also makes it possible to set an optimal using channel.

As another example, whether or not a possible channel is desirable may be verified according to whether or not a noise exists in an audio signal received over the possible channel in Step S7.

As described above, the wireless audio transmission/reception system according to the present invention can provide an optimal audio TX/RX state. Also, it is possible to conveniently set the optimal frequency. Accordingly, the user convenience can be further enhanced.

Also, reliability for the using channel can be further improved because the possible channel can be verified and because the using channel can be set automatically or manually.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A wireless audio transmission/reception system comprising:
an FM detector for detecting an occupied channel among radio FM channels;
a microprocessor for selecting a using channel that is greatly different in frequency from the detected occupied channel and thus does not interfere therewith;
an FM transmitter built in an audio replay system to transmit/receive an audio signal over the using channel; and
an external audio system for receiving and outputting the audio signal from the FM transmitter.

2. The wireless audio transmission/reception system according to claim 1, wherein the using channel is selected by verification of a plurality of possible channels.

3. The wireless audio transmission/reception system according to claim 2, wherein the possible channel is greatly different in frequency from a frequency band of the occupied channel.

4. The wireless audio transmission/reception system according to claim 2, wherein the verification is performed by noise analysis.

5. The wireless audio transmission/reception system according to claim 1, wherein the using channel is an about center frequency band between a pair of neighboring occupied channels.

6. The wireless audio transmission/reception system according to claim 1, wherein the FM detector and the microprocessor are built in the audio replay system.

7. The wireless audio transmission/reception system according to claim 1, wherein the FM detector and the microprocessor are built in the external audio system.

8. The wireless audio transmission/reception system according to claim 7, wherein the FM transmitter receives a radio audio signal from the FM transmitter.

9. The wireless audio transmission/reception system according to claim 1, wherein the FM detector is built in one of the audio replay system and the external audio system, and the microprocessor is built in the other thereof.

10. The wireless audio transmission/reception system according to claim 1, wherein the audio replay system is one of an MP3 player, a display device, a mobile terminal, a DVD player, a VCR, a set-top box, a PC, a game device, and a camcorder.

11. The wireless audio transmission/reception system according to claim 1, wherein the external audio system is one of a car audio system, an audio system, a separate speaker, and a remote controller.

12. The wireless audio transmission/reception system according to claim 1, further comprising a control signal communicator for transmitting/receiving a control signal between the audio replay system and the external audio system.

13. The wireless audio transmission/reception system according to claim 12, wherein the control signal is information about occupied channels or using channels.

14. A wireless audio transmission/reception system comprising:
an audio replay system including:
an FM detector for detecting an occupied channel among radio FM channels;
a microprocessor for automatically selecting a using channel not interfering with the detected occupied channel through a predetermined algorithm; and
an FM transmitter built in an audio replay system to transmit/receive an audio signal over the using channel; and
an external audio system including an FM receiver for receiving and outputting the audio signal from the FM transmitter.

15. The wireless audio transmission/reception system according to claim 14, further comprising a control signal communicator for transmitting/receiving a control signal between the audio replay system and the external audio system.

16. The wireless audio transmission/reception system according to claim 15, wherein the control signal includes information about the using channel.

17. A wireless audio transmission/reception system comprising:
an external audio system including:
an FM detector for detecting an occupied channel among radio FM channels;
a microprocessor for automatically selecting a using channel not interfering with the detected occupied channel through a predetermined algorithm; and
a speaker for outputting an audio signal; and
an audio replay system including an FM transmitter for transmitting the audio signal over the using channel.

18. The wireless audio transmission/reception system according to claim 17, further comprising a control signal communicator for transmitting/receiving a control signal between the audio replay system and the external audio system.

19. The wireless audio transmission/reception system according to claim 18, wherein the control signal includes information about the using channel.

20. A wireless audio transmission/reception system comprising:
an audio replay system including:
an FM transmitter for transmitting an audio signal over a using channel of a predetermined frequency band; and
a microprocessor for selecting a using channel not interfering with radio FM channels through a predetermined algorithm; and
an external audio system including:
an FM receiver for detecting a radio FM occupied channel and receiving an audio signal from the FM transmitter; and
a speaker for outputting an audio signal.

21. A method for using a wireless audio transmission/reception system, the method comprising the steps of:
searching a radio FM occupied channel of an audio replay system;
selecting one or more possible channels greatly different in frequency from the occupied channel;
selecting a using channel from the possible channels; and
transmitting an audio signal over the using channel at an FM transmitter of the audio replay system, and receiving and outputting the audio signal at an external audio system.

22. The method according to claim 21, wherein the possible channels are verified according to priority and a suitable possible channel is set to the using channel.

23. The method according to claim 21, wherein the possible channel is set to the using channel when a noise value of the possible channel is smaller than a predetermined value.

24. The method according to claim 21, wherein the possible channel is a center frequency band between a pair of occupied channels.

25. The method according to claim 21, wherein the occupied channel, the possible channel, and the using channel are obtained from the external audio system.

26. The method according to claim 21, wherein the occupied channel, the possible channel, and the using channel are obtained from the audio replay system.

27. The method according to claim 21, wherein the occupied channel is searched by the external audio system and the possible channel and the using channel are selected by the audio replay system.

28. A method for using a wireless audio transmission/reception system, the method comprising the steps of:
searching a radio FM occupied channel of an audio replay system;
transmitting information about the occupied channel to the audio replay system;
selecting a using channel not interfering with the occupied channel; and
transmitting an audio signal over the using channel at an FM transmitter of the audio replay system, and receiving and outputting the audio signal at the external audio system.
